(19) United States
(12) Patent Application Publication
(10) Pub. No.: US 2008/0195575 A1
(43) Pub. Date: Aug. 14, 2008

(54) ELECTRONIC DATA DISPLAY MANAGEMENT SYSTEM AND METHOD

(76) Inventor: Andreas Schiffler, Little River Gloucester Co. (CA)

Correspondence Address: BERESKIN AND PARR, 40 KING STREET WEST, BOX 401, TORONTO, ON, M5H 3Y2, omitted

(21) Appl. No.: 11/674,094

(22) Filed: Feb. 12, 2007

(51) Int. Cl. G06F 17/30

(52) U.S. Cl. 707/1

(57) ABSTRACT

A system and method for providing personalized content to a user on a personalized portion of a webpage. The personalized content is selected based on one or more user attributes using two dimensional lookup tables that contain indexes to the appropriate content. The two dimensional lookup tables may be linked together and ordered according to their significance.

### FIELD

The embodiments described herein relate to a system and method for webpage personalization and more particularly to a system and method for selecting personalized content for display in a personalized portion of a webpage.

### BACKGROUND

In the past decade there has been an explosion in the use of the Internet. In particular, electronic commerce has emerged as a viable and effective way to buy and sell a vast array of goods and services. As the number of organizations conducting business on the internet increases, however, so does the difficulty in grabbing the consumer's attention. With so much variety available on the internet, a website must be able to present the consumer with information which is relevant to them without requiring them to search the entire site. For this reason, the personalization of web sites has become increasingly popular.

Personalization can also be a key ingredient in achieving marketing goals by making each consumer visit to a website more effective. Internet advertising is costly and current advertising technologies simply send users who click on a particular advertisement to a website at a per-click charge. It is up to the website to capitalize on this visit and “convert” the visitor into a customer or achieve some other marketing objective.

Normally, a web server will return the same HTML content in response to a browser request regardless of the user or the circumstances. With personalization, however, some or all of the webpage may be customized to include the information that will be relevant to the particular user.

There are a number of mechanisms that can be used to employ personalized content on a webpage. Many of these, however, may be difficult to employ and allow only simple logic to be used in determining what information would be the most pertinent. Thus, it would be desirable to have a personalization method that presents relevant information using a flexible and extensible selection mechanism. It would also be desirable to have a personalization method which can apply definite rules to dynamic information.

### SUMMARY

The embodiments described herein provide in one aspect, a method of providing personalized content to a user on a personalized portion of a webpage using a content index database wherein the content index database includes a user attribute priority list and one or more groups of content lists, the user attribute priority list containing one or more user attribute types and each group of content lists containing a content attribute type and one or more content lists, each content list containing one or more content attribute values and one or more content indexes, the method comprising:
(a) selecting a user attribute type associated with the user from the user attribute priority list;
(b) determining one or more user attribute values based on the user attribute type;
(c) selecting a group of content lists from the content index database whose content attribute type matches the user attribute type;
(d) searching the group of content lists for one or more appropriate content lists whose one or more content attribute values correspond to the one or more user attribute values; and
(e) if at least one appropriate content list is found:
   (i) selecting one of the one or more appropriate content lists;
   (ii) selecting an appropriate content index from the selected appropriate content list based on an optimization algorithm;
   (iii) retrieving an appropriate content item using the appropriate content index; and
   (iv) displaying the appropriate content item in the personalized portion of the webpage.

The embodiments described herein provide in another aspect, a system for providing personalized content to a user on a personalized portion of a webpage using a content index database wherein the content index database includes a user attribute priority list and one or more groups of content lists, the user attribute priority list containing one or more user attribute types and each group of content lists containing a content attribute type and one or more content lists, each content list containing one or more content attribute values and one or more content indexes, the system comprising:
(a) a memory for storing the content index database;
(b) a processor couple to the memory for:
   (i) selecting a user attribute type associated with the user from the user attribute priority list;
   (ii) determining one or more user attribute values based on the user attribute type;
   (iii) selecting a group of content lists from the content index database whose content attribute type matches the user attribute type;
   (iv) searching the group of content lists for one or more appropriate content lists whose one or more content attribute values correspond to the one or more user attribute values; and
   (v) if at least one appropriate content list is found:
      (A) selecting one of the one or more appropriate content lists;
      (B) selecting an appropriate content index from the selected appropriate content list based on an optimization algorithm;
      (C) retrieving an appropriate content item using the appropriate content index; and
      (D) displaying the appropriate content item in the personalized portion of the webpage.

Further aspects and advantages of the embodiments described herein will appear from the following description taken together with the accompanying drawings.

### BRIEF DESCRIPTION OF THE DRAWINGS

For a better understanding of the embodiments described herein and to show more clearly how they may be carried into effect, reference will now be made, by way of example only, to the accompanying drawings which show at least one exemplary embodiment, and in which:

FIG. 1A is a block diagram of an exemplary embodiment of a personalization mechanism;

FIG. 1B is a block diagram of an exemplary embodiment of a personalization system;

FIG. 2 is a flowchart diagram that illustrates a method used to load personalized content onto a webpage;

FIG. 3 is a flowchart diagram that illustrates an exemplary embodiment of a method used to select personalized content;

FIG. 4 is a block diagram that illustrates an exemplary content list group; and

FIG. 5 is a block diagram that illustrates two exemplary content list groups and an exemplary default content list.

It will be appreciated that for simplicity and clarity of illustration, elements shown in the figures have not necessarily been drawn to scale. For example, the dimensions of some of the elements may be exaggerated relative to other elements for clarity.

### DETAILED DESCRIPTION

It will be appreciated that for simplicity and clarity of illustration, where considered appropriate, reference numerals may be repeated among the figures to indicate corresponding or analogous elements or steps. In addition, numerous specific details are set forth in order to provide a thorough understanding of the exemplary embodiments described herein. However, it will be understood by those of ordinary skill in the art that the embodiments described herein may be practiced without these specific details. In other instances, well-known methods, procedures and components have not been described in detail so as not to obscure the embodiments described herein. Furthermore, this description is not to be considered as limiting the scope of the embodiments described herein in any way, but rather as merely describing the implementation of the various embodiments described herein.

The embodiments of the systems and methods described herein may be implemented in hardware or software, or a combination of both. However, preferably, these embodiments are implemented in computer programs executing on programmable computers each comprising at least one processor, a data storage system (including volatile and non-volatile memory and/or storage elements), at least one input device, and at least one output device. For example and without limitation, the programmable computers may be a personal computer, laptop, personal data assistant, and cellular telephone. Program code is applied to input data to perform the functions described herein and generate output information. The output information is applied to one or more output devices, in known fashion.

Each program is preferably implemented in a high level procedural or object oriented programming and/or scripting language to communicate with a computer system. However, the programs can be implemented in assembly or machine language, if desired. In any case, the language may be a compiled or interpreted language. Each such computer program is preferably stored on a storage media or a device (e.g. ROM or magnetic diskette) readable by a general or special purpose programmable computer, for configuring and operating the computer when the storage media or device is read by the computer to perform the procedures described herein. The inventive system may also be considered to be implemented as a computer-readable storage medium, configured with a computer program, where the storage medium so configured causes a computer to operate in a specific and predefined manner to perform the functions described herein.

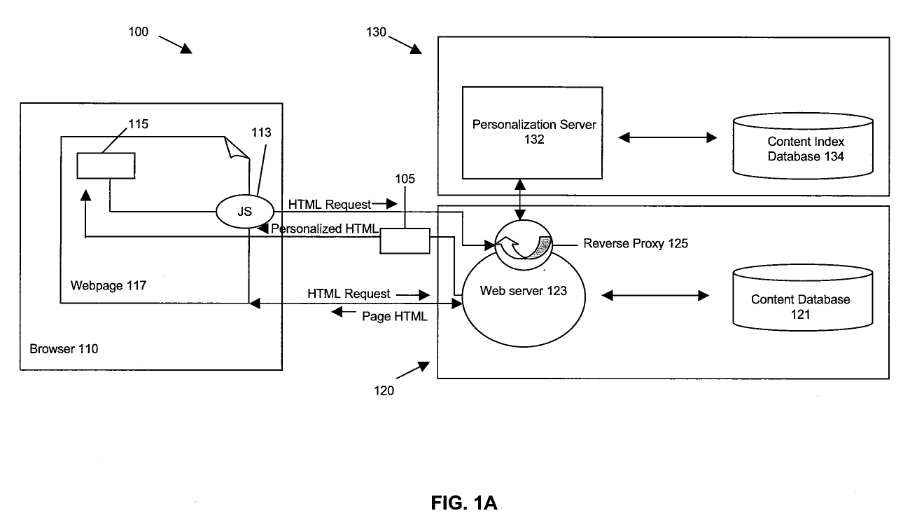

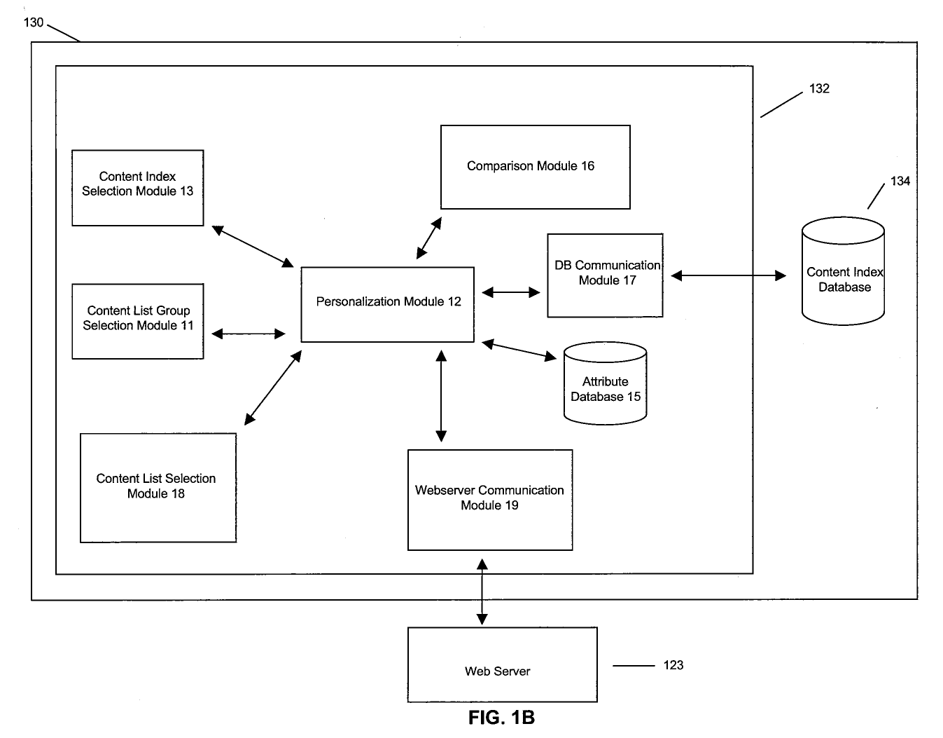

Reference is first made to FIG. 1A, which is a block diagram that illustrates an exemplary embodiment of a personalization mechanism 100. There are three main elements of the personalization mechanism 100, namely a browser 110, a website host 120 and a personalization system 130.

The browser 110 may be any program capable of receiving and displaying information from the Internet. For example and without limitation, the browser 110 may be a web browser such as Internet Explorer or Firefox running on a personal computer or laptop or it may be browsing software associated with a web enabled cellular phone or personal data assistant. The browser 110 is controlled by a user viewing a personalized webpage 117. The personalized webpage 117 will normally be written in HyperText Markup Language (HTML) or another suitable language.

The personalized portion 115 of the personalized webpage 117 will display the personalized content 105. The personalized portion 115 includes a personalization script 113 which will allow personalized webpage 117 to obtain the personalized content 105. The personalization script 113 may, for example, be JavaScript instructions embedded in the HTML of the webpage 117. Alternatively, the personalization script 113 may be an ActionScript based client program interacting with a Flash-based display. It should be understood that the personalized portion 115 of the webpage 117 may be of any size or shape and may cover the entire webpage or only a portion thereof. Moreover, there may be any number of personalized portions 115 on the same personalized webpage 117.

The website host 120 comprises two main components, a web server 123 and a content database 121. The website host 120 will normally be owned and operated by the company or organization to which the website relates or by another company or organization hired by them to do so. The content database 121 contains personalized content that may be placed in personalized portion 115 of webpage 117. The web server 123 provides the browser 110 with the personalized webpage 117 as well as with the personalized content 105 which is to appear in the personalized portion 115. The personalized webpage 117 may be part of a larger website hosted by the web server 123. The web server 123 also includes a reverse proxy 125.

The personalization system 130 comprises a personalization server 132 and a content index database 134. The personalization server 132 determines what personalized content 105 is most appropriate for display in the personalized portion 115 of the personalized webpage 117. The personalization server 132 will be discussed in greater detail with reference to FIG. 1B. The content index database 134 stores an index to the location of all the possible personalized content that may be displayed on the personalized webpage 117. The personalization system 130 may be separate from the website host 120 or they may be part of one integrated system. Similarly, the personalization system 130 may be remote from the website host 120 or they may be situated in the same location. The personalization system 130 may also include another database (not shown) for storing personalized content.

If for any reason the reverse proxy 125, the personalization system 130 or any component thereof is unavailable or unreachable, a default content item may be sent by the web server 123 to the browser 110 to be displayed in the personalized portion 115.

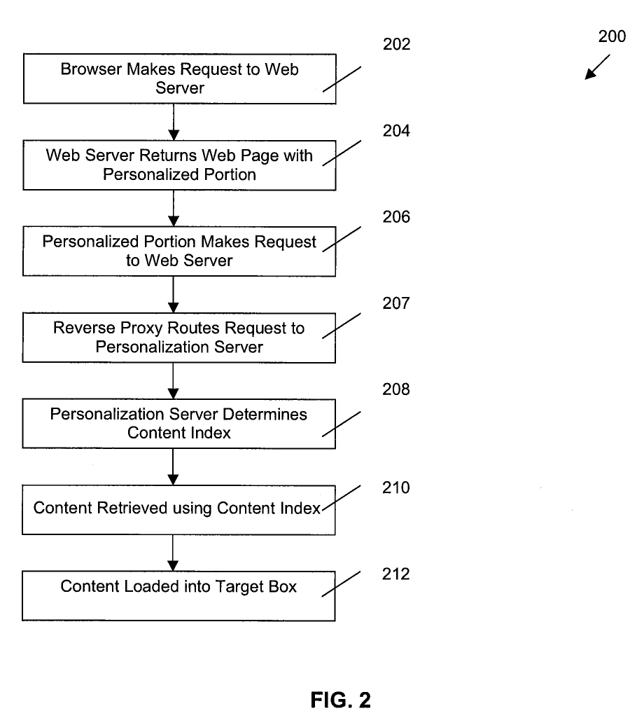

Referring now to FIG. 2, there is shown a flowchart diagram illustrating the method 200 used to load personalized content into the personalized portion 115 of the personalized webpage 117.

The method 200 is initiated when the browser 110 makes an HTML request to the web server 123 at step (202). At step (204), the web server returns the requested webpage 117 that is loaded into the browser 110. As mentioned above, the webpage 117 includes a personalized portion 115 and contains a personalization script 113. Once the webpage 117 is loaded, personalization script 113 will be initiated and another HTML request is sent to the web server 123 at step (206).

This request may include information such as a website identifier, configuration specific data such as a content path and version, and request specific data such as the URL of the requesting webpage, the user agent, the user's IP address, the referring URL, the timezone in which the browser is located and the target names as well as any relevant cookies stored on the user's computer. The user agent text can be augmented with information from plugin detections (e.g. Is Flash available? What is the version of Quicktime?). At step (207), the web server 123 uses reverse proxy 125 to route the request to the personalization server 132 in order to satisfy possible browser security restrictions.

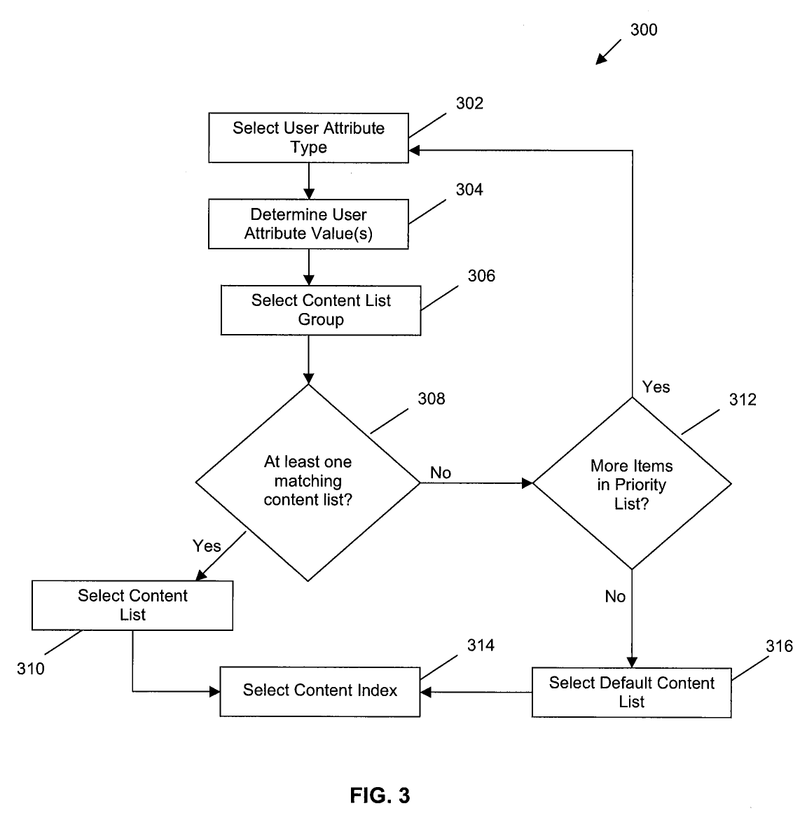

At step (208), the personalization server 132 determines the index of the appropriate personalized content 105 using content index database 134. This step will be described in greater detail with reference to FIG. 3. The content index may be an index to content stored on content database 121 or it may be an index to content that will be retrieved elsewhere. For example, the personalized content associated with the content index may be stored on the personalization server 130 itself. Note that the personalized HTML may also contain references to images, iframes, Flash, and the like that are stored elsewhere.

If the selected content index refers to content stored in the content database 121 then this content index is passed back to the web server 123. At step (210), the web server 123 retrieves the desired personalized content 105 from content database 121 and sends it to browser 110. At step (212), the personalized content 105 is loaded into the personalized portion 115. Technology such as Ajax web development techniques may be advantageously employed to allow the personalized content to be loaded into the personalized portion of the webpage without the need to reload the entire page.

It should be noted that the request sent by the personalization script 113 to the web server 123 may be separated into two or more separate requests. For example, a first request may be sent when the personalization script 113 is first loaded including some or all of the data described above. A second request may be sent once the webpage 117 has finished loading and the personalized portions 115 have been realized. This may speed up the personalization process.

Reference is now made to FIG. 1B, which is a block diagram of an exemplary embodiment of a personalization system 130 comprising the personalization server 132 and the content index database 134. The personalization server 132 contains, but is not limited to, a personalization module 12, a content list group selection module 11, a content list selection module 18, a comparison module 16, a content index selection module 13, a content index database communication module 17, a web server communication module 19 and an attribute database 15.

Content index database 134 contains indexes for the locations of all the personalized content 105 that may be loaded into the personalized portion 115. These content indexes are organized into two dimensional lookup tables called content list groups. Each content list group contains a content attribute type and one or more content lists. Each content list contains none, one or more content attribute values and one or more content indexes.

The attribute database 15 contains user attribute values, such as the users geographic location or user profile, as well as source data from which these values are derived, such as the user's IP address or the URL of the webpage which referred the user the current webpage 117 (the referring webpage). This data may be collected at different times such as when the user first enters the website, when the personalized webpage 117 is requested or when personalized content is requested. For example, as mentioned above, the referring URL may be included in the request sent from the personalized portion 115. User attribute values may relate to a user's intention, to a user group or classification in which the user can be placed, to time events or to area reach.

Some source data may also be stored and used for multiple webpages 117 in a website. For example, the referring URL will only be available from the first webpage 117 in the website to which a user is referred. This information, however, may be stored and used for other webpages 117 in the website which include personalized portions 115.

The attribute database 15 also contains an attribute priority list which includes all the user attribute types on which content selection may be based and ranks these user attributes types in order of importance. There will preferably be a one to one correspondence between the user attribute types contained in the attribute priority list and the content attribute types of the available content list groups. In other words, each content attribute type will appear on the attribute priority list and there will be no entries in the attribute priority list that do not have a corresponding content list group

The personalization module 12 receives requests from the website host 120 via web the server communications module 19. The personalization module 12 will retrieve the appropriate content index from the content index database 134 using the database communication module 17 and return it to the web server 123 using the web server communication module 19. The appropriate content index will be determined by personalization module 12 using the content list group selection module 11, the content list selection module 18, the content index selection module 13, the comparison module 16 and the attribute database 15 as will be described with reference to FIG. 3.

Reference will now be made to FIG. 3. In FIG. 3, there is shown a flowchart diagram of illustrating the method 300 used to determine the content index of the appropriate personalized content 105 to be loaded into a personalized portion 115 on a personalized webpage 117. The method 300 is an expansion of step (208) in FIG. 2.

At step (302), the method 300 selects a user attribute type using the attribute priority list stored in attribute database 15. As mentioned above, the attribute priority list contains a list of all the possible user attribute types arranged in order of importance. The most important, or highest priority, user attribute type is selected first.

At step (304), the user attribute values of the selected user attribute type are retrieved from the attribute database 15. This may be a single value or a list of values. How this step is performed will depend on the user attribute type selected and the information available.

For example, as mentioned above, the attribute database may contain the referring URL. This URL may be used to extract a list of keywords which are presumably of some importance to the user. For example, if the user was referred to personalized webpage 117 from a search engine, the words which had been searched in order to get to the present site will be included in the referring URL. Presumably, these words are an indication of the reason the user is visiting the personalized website 117 and, hence, serve as a useful tool in determining the content which would be most of interest to the user.

Alternatively, the user's IP address may be used to estimate the user's geographic location such as the city, country or coordinate location in which the user is situated, and used to personalized the content presented. For instance, the content displayed may be a list of upcoming events in the city in which the user is located. Alternatively, different content may be displayed depending on whether or not a certain holiday is celebrated in the country in which the user is located.

Geographic location can also be used to determine the time of day and the day of the week in the user's location. This information may be useful, for example, in determining whether the user is likely at home or at work and personalizing the content accordingly. Information regarding the country in which the user is located may be combined with the time of day in the user's location in order to more precisely predict what a user might be doing at a given time depending on local customs. For example, the time at which dinner is eaten tends to be quite different in Canada than it is in Spain. The combination of the time of day, the day of the week, the country and the time zone may be useful in targeting advertisements to television shows.

It should be noted that the user's geographic location may not always be successfully derived using the user's IP address or through other methods. Consequently, the personalization system 130 may allow the user to override this, or any other, user attribute. For example, a webpage 117 may include an interactive “City Picker” that allows a user to choose a more appropriate location.

Another alternative is to use HTTP cookies that are sent to the browser 110 by a web server 123. HTTP cookies can be used to maintain a “state” across time and browsing sessions and also between different web servers. For example, an HTTP cookie associated with the web server 123 may be maintained for a particular user across multiple requests. This may be used to track visits or clicks but can also be used for more elaborate analysis such as click-stream data-mining in order to determine a user's intentions in more detail. HTTP cookies from other web servers may also be used to gather information about a particular user.

The information gathered from HTTP cookies can be passed to the personalization server 132 and stored in the attribute database 15. This information may be used to map the user to a user profile. For example, an HTTP cookie may contain information regarding how many visits a user has made to the web site and this information may be used to map the user to user profiles related to first time users, occasional customers and frequent customers. The number of clicks made by a user may on particular categories of links in the website may also be tracked and used as to map a user to a user profile related to the user's specific interests.

At step (306), the content list group whose content attribute type matches the selected user attribute type is chosen using the content list selection module 11. It should be noted that steps (304) and (306) may occur in either order.

The selected content list group is searched at step (308) to determine if there is at least one content list in the content list group whose content attribute values correspond to the user attribute values. This may mean that the content attribute values and the user attribute values are equal or, if they both consist of lists of values, it may mean that at least one of the values in the list of values for the user attribute values appears in the list of values for the content attribute values. The content attribute values of each content list are compared to the user attribute values using comparison module 16.

If at least one content list is found at step (308), the method 300 proceeds to step (310) where a content list is selected using the content list selection module 18. In some circumstances, more than one content list may correspond to the user attribute values. Accordingly, the content lists may be ordered according to priority such that if there is more than one matching content list then the content list with the highest priority will be chosen. At step (314), a content index is selected from the selected content list using content index selection module 13.

If none of the content attribute values of the content lists in the selected content list group correspond to the user attribute values then the method 300 proceeds to step (312).

At step (312), the attribute priority list is checked to determine if there are any user attribute types on the list that have not yet been selected. If so, the method 300 returns to step (302) and the user attribute type with the highest priority that has not yet been applied is selected. Otherwise, the method proceeds to step (316) and a default content list is selected. At step (314), a content index is selected from the default content list using content index selection module 13.

The content index selection module 13 may select the content index from the selected content list using an optimization algorithm. For example, the optimization algorithm may be a fixed algorithm in which the same item is always selected or it may be a sequential algorithm in which the next item in a per-visitor tracked sequence is chosen. With a sequential algorithm, once the user has been presented with each item in the content list, the optimization algorithm may start again with the first item on the list or may continue to show the last item in the list from then on. Sequential algorithms may use unit intervals, in which the next item in the content list is always chosen, or interval numbers, where the optimization algorithm will only move to the next item in the list after a certain number of visits. Alternatively, the optimization algorithm may select an item randomly according to a pre-determined set of probabilities. These probabilities may be equal or weights may be assigned to items in the list such that certain items are more likely to be selected than others.

The content indexes within a content list group may also be ordered to maximize the relevance of the information presented to the user. For example, if the content associated with a particular content index has shown to be particularly useful in the past, for example if it statistically has resulted in more user clicks, then this content index may be placed higher in the list so that it may be accessed more often.

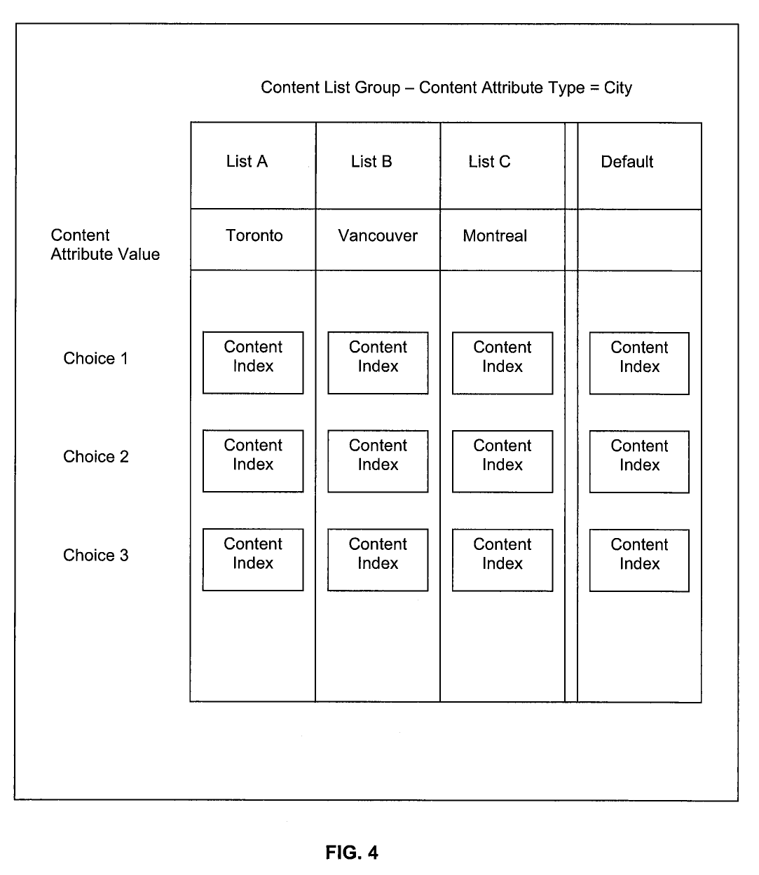

Reference will now be made to FIG. 4, showing a block diagram of an exemplary content list group that will be used to illustrate the method 300. In this example we will assume there is only one content group list in the content index database 134 and hence only one user attribute type in the attribute priority list. The user attribute type is the city in which the user is located. Thus, at step (302), the user attribute type “city” will be selected.

At step (304), the city in which the user is located will be determined. Since the user can only be in one city at a time, there will be a single user attribute value. The city in which the user is located may be derived from the user's IP address that was passed to the personalization server 132 when the personalization request was made. We will assume for the purposes of this example that the user is located in Vancouver.

At step (306), the content list group is selected. As there is only one content list group in this example, it must be the one selected. At step (308), the content attribute values of each of the content lists are compared to the user attribute value “Vancouver” and it will be determined that List B is a match. The method 300 will then proceed to step (310). In this example, there could only be one matching content list and hence, the priority of the content lists is not an issue. List B will be selected at step (310).

List B may contain a list of content indexes of content related to the city of Vancouver such as images of popular attractions or a list of upcoming events. At step (314), a content index is selected from Content List B. If the optimization algorithm used at step (314) is a sequential algorithm and this is the user's first time to the web site then Choice 1 will be selected.

Suppose now that the user is located in Winnipeg rather than in Vancouver. In this case, at step (308), it would be determined that there are no lists in the content list group whose content attribute value matches the value “Winnipeg”. The method 300 would then proceed to step (312). Since there was only one type of attribute in the attribute priority list, it will be determined that there are no user attribute types in the list which have not been applied. In this case, the content index will be selected from the default content list at step (314).

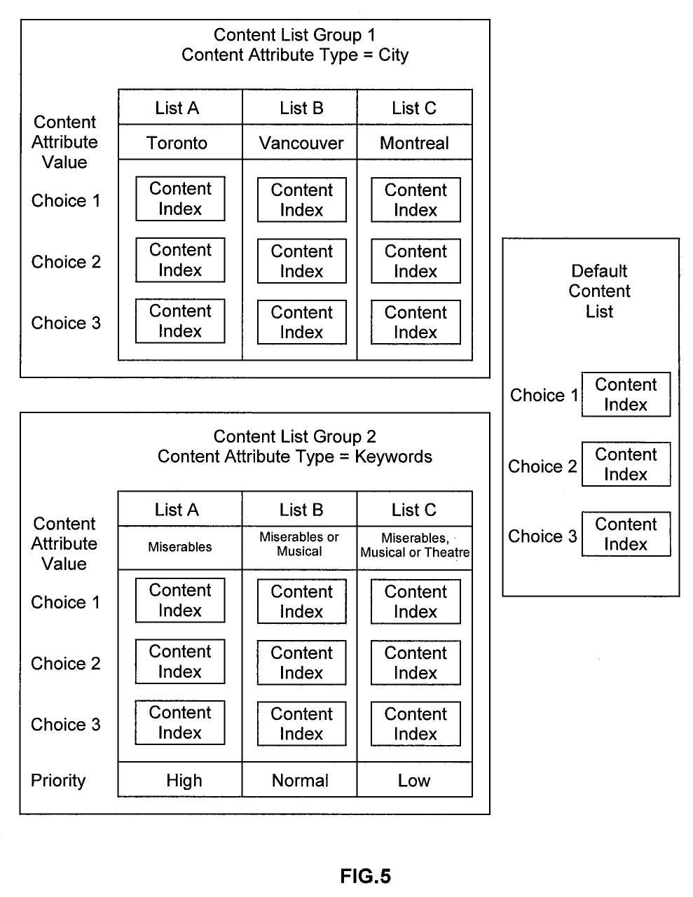

Reference will now be made to FIG. 5, showing a block diagram of multiple exemplary content list groups which will be used to illustrate the method 300. In the example illustrated in FIG. 5, there are two content list groups. Content List Group 1 contains three content lists: List A, List B and List C. The content attribute type of Content List Group 1 is the city in which the user is located.

Content List Group 2 also contains three lists: List D, List E and List F. The content attribute type of Content List Group 2 is one or more keywords that are derived from the URL of the referring webpage. The content attribute value of List A is “Miserables”. If a referring URL contains this word then List A will be a match. If a referring URL contains either “Miserables” or “Musical” then List B will be a match. Finally, if the referring URL contains any of the words “Theatre”, “Musical” or “Miserables” then List C will be a match.

In this example, the user attribute values associated with Content List Group 2 will be a list of values. As more than one content list from Content List Group 2 may correspond to the user attribute values, the three lists in Content List Group 2 each have an assigned priority. Priorities have been assigned based on how specific the content attribute values are. List A has been assigned the highest priority because it contains only one very specific keyword.

The attribute priority list will contain two entries: city and keywords. We will assume that city has a higher priority than keywords on the attribute priority list and, hence, the user attribute type selected at step (302) will be “city”. We will again assume that the user is located in Winnipeg and, hence, the user attribute value determined at step (304) is “Winnipeg”. Content List Group 1 will be selected at step (306) and at step (308) it will be determined that none of the content lists are a match to the user attribute values. The method 300 will then proceed to step (312).

At step (312), the attribute priority list will again be checked and it will be determined that there is at least one item on the attribute priority list which has not yet been selected, namely keywords. This user attribute type will be selected at step (302).

At step (304), a list of keywords will be extracted from the referring URL by analyzing it for common patterns used by search engines. For example, a search on Google will typically generate a referring URL containing the domain name google.com and a query string component “q=” which precedes the keyword entered by the user. We will assume in this example that the words “musical” and “theatre” are found in the referring URL. At step (306), Content List Group 2, whose content attribute type is keywords, is selected.

The content attribute values of each content list in Content List Group 2 will be compared to the keywords discovered in step (304) using comparison module 16. In this case, Lists E and F produce matches. Since there is at least one match, the method 300 proceeds from step (308) to (310). At step (310), the matching content list with the highest priority, List E, is selected. A context index is then selected from List E using the content index selection module 13. As mentioned above, the content index selection module may employ an optimization algorithm in order to make this selection.

If none of the content lists in Content List Group 2 had matched the user attribute values, if for example the keywords had been “hockey” and “sports”, then the default content list would have been selected at step (316) and the content index would have been chosen from the default content list at step (314).

While the above description provides examples of the embodiments, it will be appreciated that some features and/or functions of the described embodiments are susceptible to modification without departing from the spirit and principles of operation of the described embodiments. Accordingly, what has been described above has been intended to be illustrative of the invention and non-limiting and it will be understood by persons skilled in the art that other variants and modifications may be made without departing from the scope of the invention as defined in the claims appended hereto.

1. A method of providing personalized content to a user on a personalized portion of a webpage using a content index database wherein the content index database includes a user attribute priority list and one or more groups of content lists, the user attribute priority list containing one or more user attribute types and each group of content lists containing a content attribute type and one or more content lists, each content list containing one or more content attribute values and one or more content indexes, the method comprising:
(a) selecting a user attribute type associated with the user from the user attribute priority list;
(b) determining one or more user attribute values based on the user attribute type;
(c) selecting a group of content lists from the content index database whose content attribute type matches the user attribute type;
(d) searching the group of content lists for one or more appropriate content lists whose one or more content attribute values correspond to the one or more user attribute values; and
(e) if at least one appropriate content list is found:
(i) selecting one of the one or more appropriate content lists;
(ii) selecting an appropriate content index from the selected appropriate content list based on an optimization algorithm;
(iii) retrieving an appropriate content item using the appropriate content index; and
(iv) displaying the appropriate content item in the personalized portion of the webpage.

2. The method of claim 1, the method further comprising:
(f) if no appropriate content lists are found:
(i) determining if there is a user attribute type in the user attribute priority list which has not been selected;
(ii) if there is a user attribute type in the user attribute priority list which has not been selected, repeating (a) to (f); and
(iii) if there are no user attribute types in the user attribute priority list which have not been selected:
(A) selecting a default content list;
(B) selecting an appropriate content index from the default content list based on the optimization algorithm;
(C) retrieving an appropriate content item using the appropriate content index; and
(D) displaying the appropriate content item in the personalized portion of the webpage.

3. The method of claim 1, wherein each user attribute type in the user attribute priority list has a corresponding priority and wherein (a) further comprises selecting the highest priority user attribute type in the user attribute priority list which has not yet been selected.

4. The method of claim 1, wherein (c) further comprises assigning a priority to each content list in the selected content list group and wherein (e)(i) further comprises selecting the content list with the highest priority.

5. The method of claim 1, the method further comprising loading a default content item into the personalized portion of the webpage if at least one of:
a) no content is loaded into the personalized portion of the webpage within a predetermined period of time; and
b) the content index database is unavailable or unreachable.

6. (canceled)

7. The method of claim 1, wherein one or more of the user attribute types in the user attribute priority list at least one of:
a) relates to the user's geographical location;
b) relates to at least one of:
i) the URL of the referring webpage: and
ii) the location URL associated with the user's currently shown location:
c) is the time of day in at least one of:
i) the user's geographical location: and
ii) the time zone of a browser:
d) is the number of visits the user has made to the web site.

8. The method of claim 7, wherein at least one of:
a) one or more of the user attribute types in the user attribute priority list is at least one of:
i) the country in which the user is located;
ii) the city in which the user is located; and
iii) the coordinates in which the user is located;
b) the user's geographical location is derived from the user's IP address.

9. (canceled)

10. (canceled)

11. (canceled)

12. (canceled)

13. The method of claim 7, wherein one or more of the user attribute types in the user attribute priority list is at least one of:
a) list of keywords located in the URL of the referring webpage; and
b) a list of regular expressions matching in the URL of the referring webpage.

14. (canceled)

15. (canceled)

16. (canceled)

17. (canceled)

18. (canceled)

19. (canceled)

20. The method of claim 1, wherein one or more of the user attribute types in the user attribute priority list is at least one of:
a) user profile;
b) the combination of the time of day in the user's geographical location and the country in which the user is located;
c) the combination of the time of day and the day of the week in the user's geographical location; and
d) the combination of the time of day and the day of the week in the user's geographical location and the time zone and country in which the user is located.

21. The method of claim 20, wherein at least one of:
a) the one or more user attribute values are determined by mapping a regular expression found in a cookie to a user profile; and
b) the number of clicks made by a user on links divided into one or more categories is tracked and the one or more user attribute values are determined by mapping a range of user clicks to a user profile.

22. (canceled)

23. (canceled)

24. The method of claim 1, wherein the optimization algorithm at least one of:
a) selects the first item a list;
b) selects the next item in a per-visitor tracked sequence;
c) randomly selects an item from a list according to a pre-determined set of probabilities;
d) selects the next item in a per-visitor tracked sequence if the user has not previously clicked on the current item; and
e) selects the next item in a per-visitor tracked sequence if the user has not previously clicked on the current category of items.

25. (canceled)

26. (canceled)

27. (canceled)

28. (canceled)

29. (canceled)

30. (canceled)

31. The method of claim 1, wherein one or more of the content lists are ordered using a maximization function.

32. A computer-readable medium upon which a plurality of instructions are stored, the instructions for performing the steps of the method as claimed in claim 1.

33. A system for providing personalized content to a user on a personalized portion of a webpage using a content index database wherein the content index database includes a user attribute priority list and one or more groups of content lists, the user attribute priority list containing one or more user attribute types and each group of content lists containing a content attribute type and one or more content lists, each content list containing one or more content attribute values and one or more content indexes, the system comprising:
(a) a memory for storing the content index database;
(b) a processor coupled to the memory for:
(i) selecting a user attribute type associated with the user from the user attribute priority list;
(ii) determining one or more user attribute values based on the user attribute type;
(iii) selecting a group of content lists from the content index database whose content attribute type matches the user attribute type;
(iv) searching the group of content lists for one or more appropriate content lists whose one or more content attribute values correspond to the one or more user attribute values; and
(v) if at least one appropriate content list is found:
(A) selecting one of the one or more appropriate content lists;
(B) selecting an appropriate content index from the selected appropriate content list based on an optimization algorithm;
(C) retrieving an appropriate content item using the appropriate content index; and
(D) displaying the appropriate content item in the personalized portion of the webpage.

34. The system of claim 33, wherein the processor is further configured for:
(vi) if no appropriate content lists are found:
(A) determining if there is a user attribute type in the user attribute priority list which has not been selected;
(B) if there is a user attribute type in the user attribute priority list which has not been selected, repeating (i) to (vi); and
(C) if there are no user attribute types in the user attribute priority list which have not been selected:
(I) selecting a default content list;
(II) selecting an appropriate content index from the default content list based on the optimization algorithm;
(III) retrieving an appropriate content item using the appropriate content index; and
(IV) displaying the appropriate content item in the personalized portion of the webpage.

35. The system of claim 33, wherein each user attribute type in the user attribute priority list has a corresponding priority and wherein (i) further comprises selecting the highest priority user attribute type in the user attribute priority list which has not yet been selected.

36. The system of claim 33, wherein (b)(iii) further comprises assigning a priority to each content list in the selected content list group and wherein (b)(v)(A) further comprises selecting the content list with the highest priority.

37. The system of claim 33, wherein the processor is further configured for loading a default content item into the personalized portion of the webpage if at least one of:
a) no content is loaded into the personalized portion of the webpage within a predetermined period of time; and
b) the content index database is unavailable or unreachable.

38. (canceled)

39. The system of claim 33, wherein one or more of the user attribute types in the user attribute priority list at least one of:
a) relates to the user's geographical location;
b) relates to at least one of:
i) the URL of the referring webpage; and
ii) the location URL associated with the user's currently shown location;
c) is the time of day in at least one of:
i) the user's geographical location; and
ii) the time zone of a browser;
d) is the number of visits the user has made to the web site.

40. The system of claim 39, wherein at least one of:
a) one or more of the user attribute types in the user attribute priority list is at least one of:
i) the country in which the user is located;
ii) the city in which the user is located; and
iii) the coordinates in which the user is located;
b) the user's geographical location is derived from the user's IP address.

41. (canceled)

42. (canceled)

43. (canceled)

44. (canceled)

45. The system of claim 39, wherein one or more of the user attribute types in the user attribute priority list is at least one of:
a) a list of keywords located in the URL of the referring webpage; and
b) a list of regular expressions matching in the URL of the referring webpage.

46. (canceled)

47. (canceled)

48. (canceled)

49. (canceled)

50. (canceled)

51. (canceled)

52. The system of claim 33, wherein one or more of the user attribute types in the user attribute priority list is at least one of:
a) a user profile;
b) the combination of the time of day in the user's geographical location and the country in which the user is located:
c) the combination of the time of day and the day of the week in the user's geographical location; and
d) the combination of the time of day and the day of the week in the user's geographical location and the time zone and country in which the user is located.

53. The system of claim 52, wherein at least one of:
a) the one or more user attribute values are determined by mapping a regular expression found in a cookie to a user profile; and
b) the number of clicks made by a user on links divided into one or more categories is tracked and the one or more user attribute values are determined by mapping a range of user clicks to a user profile.

54. (canceled)

55. (canceled)

56. The system of claim 33, wherein the optimization algorithm at least one of:
a) selects the first item a list;
b) selects the next item in a per-visitor tracked sequence;
c) randomly selects an item from a list according to a pre-determined set of probabilities;
d) selects the next item in a per-visitor tracked sequence if the user has not previously clicked on the current item; and
e) selects the next item in a per-visitor tracked sequence if the user has not previously clicked on the current category of items.

57. (canceled)

58. (canceled)

59. (canceled)

60. (canceled)

61. (canceled)

62. (canceled)

63. The system of claim 33, wherein one or more of the content lists are ordered using a maximization function.
